(19) United States
(12) Patent Application Publication
(10) Pub. No.: US 2023/0229116 A1
(43) Pub. Date: Jul. 20, 2023

(54) DISPLAY DEVICES AND ELECTRONIC APPARATUSES COMPRISING SAME

(71) Applicant: Dayton Technologies Limited, Hong Kong (CN)

(72) Inventor: Paul Anthony Yuen, Hong Kong (CN)

(21) Appl. No.: 18/009,340

(22) PCT Filed: Jan. 18, 2021
(86) PCT No.: PCT/IB2021/050328

§ 371 Date: Dec. 9, 2022

(30) Foreign Application Priority Data
Jun. 11, 2020 (HK) 22020009147.2

(51) Int. Cl. G04G 9/00; G04B 19/10; G04B 19/12

(52) U.S. Cl. CPC G04G 9/0041; G04B 19/10; G04G 9/0088; G04B 19/12

(57) ABSTRACT

A display device comprising a display panel (10) and an electroluminescent light source (20), wherein the display panel (10) includes an intermediate layer and a display surface (12), wherein the electroluminescent light source (20) is configured to project light through the intermediate layer to form an information display on the display surface (12), and wherein the intermediate layer comprises one or more layers selected from crystalized calcium carbonate, porcelain, ceramics, china.

### FIELD

The present disclosure relates to display devices and electronic apparatuses comprising same.

### BACKGROUND

Many electronic apparatuses comprise an electroluminescent display for time variant information display. An electroluminescent display usually comprises an electroluminescent display surface which requires a window on a data display surface to expose the display surface for viewing. The window or the data display surface can be somewhat unsightly and may adversely affect the design integrity of a background, such as an aesthetically designed background.

### DISCLOSURE

There is disclosed a display device comprising a display panel and an electroluminescent light source, wherein the display panel includes an intermediate layer and a display surface, wherein the electroluminescent light source is configured to project light through the intermediate layer to form an information display on the display surface, and wherein the intermediate layer comprises one or more layers selected from crystalized calcium carbonate, porcelain, ceramics, China.

The intermediate layer may comprise hexagonal platelets of crystalized calcium carbonate of 10 μm-20 μm wide.

The intermediate layer may comprise platelets of crystalized calcium carbonate of 0.4 μm-0.6 μm thick.

The intermediate layer may comprise platelets of aragonite.

The intermediate layer may comprise a calcareous layer.

The intermediate layer may comprise platelets of aragonite arranged in a plurality of parallel lamina.

The intermediate layer may be a polished mollusk shell.

The intermediate layer may comprise a polished nacreous layer of a mollusk shell.

The display surface may be a polished surface comprising platelets of crystalized calcium carbonate.

The display surface may be a polished surface comprising platelets of aragonite.

The display surface may be a nacreous surface.

The display surface may be an iridescent surface.

The display panel may have a thickness of between 0.4 mm and 0.5 mm.

The electroluminescent source may be configured to generate a visible image on the display surface by providing back illumination to the display panel.

The display device may comprise a pattern generator which is configured to generate a light emitting pattern having a resolution of higher than 50, 60, 70, 80, 90, 100 pixels, per centimeter.

An electronic apparatus comprising the aforementioned display device is also disclosed.

### FIGURES

The disclosure will be described by way of example with reference to the accompanying Figures, in which:

FIG. 1 is a schematic diagram of a display arrangement according to the present disclosure,

FIG. 2 shows an electronic display apparatus comprising a display device according to the present disclosure,

FIG. 2A shows the view of the electronic display apparatus of FIG. 2 when the light source of the display device is turned on to form a light emission pattern,

FIG. 3 shows an example display panel having a nacre dial surface and a preset background pattern,

FIG. 4 is a plan view of an example apparatus according to the present disclosure with no electroluminescent message generated,

FIG. 4A is a plan view of the example apparatus of FIG. 4 when an electroluminescent message is generated,

FIGS. 5A and 5B are exploded views of the example apparatus of FIG. 4,

FIG. 5C is an exploded view of the sub-assembly comprising the display module and mechanical movement assembly of the apparatus of FIG. 5B,

FIG. 5D is a cut-away view along line X-X′ of FIG. 5B of the apparatus,

FIGS. 6A, 6B, 6C and 6D are example messages generated on the active display surface of the electroluminescent display device of the example apparatus of FIG. 4,

FIG. 7 is a schematic diagram depicting example viewing of the dial surface under ambient illuminated conditions, and

FIG. 8 is an example schematic diagram showing an electronic circuit of the example apparatus of FIG. 4.

### DESCRIPTION

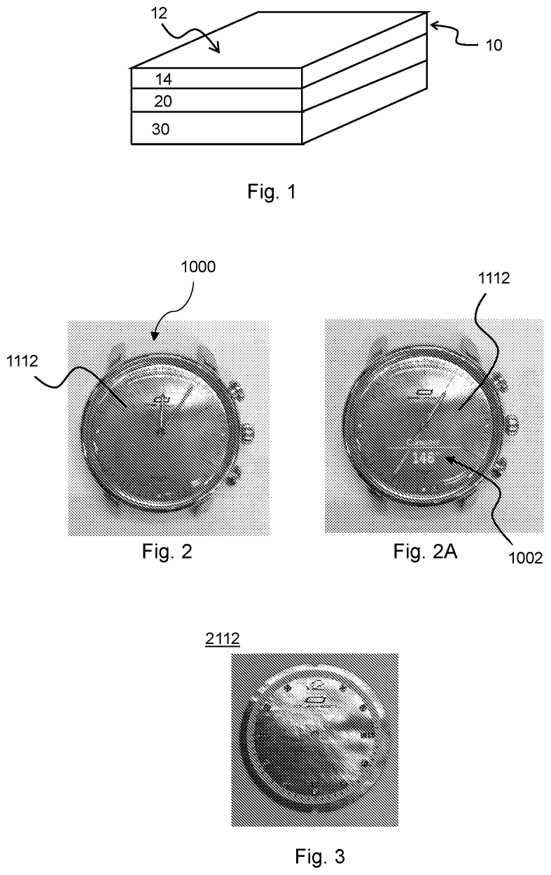

A display arrangement comprises a display panel 10, an electroluminescent source 20 and optionally an electronic circuitry 30, as shown in FIG. 1. The display panel comprises a first surface which is a display surface 12, a second surface which is a back surface, and a panel body 14 which is intermediate the first surface and the second surface. The electroluminescent source 20 is configured to provide back illumination to the display panel 10 whereby a visible optical image is formed on the display surface. The optical image (image in short) can be transient or non-transient, and can comprise a textual image, a non-textual image, or a combination thereof.

The electroluminescent source 20 comprises a light emitting source (light source in short) and electronic circuitry which is configured to power and control operation of the light emitting source. The electroluminescent source comprises a light emission surface which may be in juxtaposition or in abutment with the display panel 10 so that light emerging from the electroluminescent source 20 is to impinge the display panel with no or minimal attenuation. The light emission surface of the electroluminescent source and the back surface of the display panel may be in parallel to facilitate orthogonal and maximal coupling of light. The electronic circuitry may comprise or may cooperate with a pattern generator which is configured to operate the light source to generate a light emitting pattern (LEP). The light emitting pattern will appear as an optical pattern at the light emission surface and at the display surface 12.

The display panel 10 may be configured such that the light emission surface and the display surface are in parallel so that an optical image formed on the display surface is an authentic reproduction of the optical pattern formed on the light emission surface. In some embodiments, the light emission surface and the display surface are at a small acute angle so that an optical image which is a somewhat distorted version of the optical pattern is to appear on the display surface.

The light emitting source may comprise a plurality of light emitting elements. The light emitting elements are distributed and are configured to cooperate to define a light emission surface which is to project visible light towards the back surface of the display surface. A lighting element herein may be a point source having a small viewing angle (say ±15 degree about light axis) or a spread source having a large viewing angle (say, larger than ±15 degree about light axis). The light source may comprise a combination of both point sources and spread light sources to produce preferred visual effects. The light emitting elements may be arranged in arrays, matrixes, or a combination thereof. The lighting element may be a discrete component or one of a plurality of lighting element integrally formed together.

The electronic circuitry may include a controller which is configured to operate the pattern generator or the pattern generator may be integrally built as part of the controller. The controller may comprise a data storage device for storing transient and/or non-transient data. The data storage device may comprise volatile and/or non-volatile memories. The controller is configured to operate the lighting elements whereby a light emitting pattern which is set according to predetermined rules and/or algorithm is generated.

The display device is usually configured so that its display surface is oriented to face a user during normal use so that an optical image on the display surface is in the user's line of sight. Therefore, the first surface of the display panel is referred to as a front surface of the display panel and the second surface is referred to as a back surface of the display panel. The example electroluminescent source 20 is configured to project visible light towards the display panel so that light originating from the electroluminescent source is to impinge on the display panel at the back surface and then forms a visible image on the front surface after traversing through the panel body.

The display device may be configured such that the electroluminescent source, or at least the plurality of light emitting elements is visually concealed underneath or behind the display surface when the display device is turned off during normal or ordinary use.

The display device may be configured such that the electroluminescent source, or at least the plurality of light emitting elements is visually concealed underneath or behind the display surface when the display device is turned on to generate an image pattern during normal or ordinary use, while the optical image pattern which is cast on the display surface is readable under naked human eyes.

The panel body 14 is heavily light attenuating so that the back illumination is substantially attenuated after traversing through the panel body. The attenuation rate may be at 70%, 80% or more, and can be as high as 90% to 98%. A panel body having such a high light attenuation rate would appear opaque or at least translucent to an average viewer such as an overage user during normal or ordinary use of the display device. Normal or ordinary use herein means that the display device is used indoors under normal ambient room illumination or used outdoors under mild or diffused sunlight illumination conditions. An illumination level of between 25 lux and 1,000 lux is taken as normal ambient room illumination herein. An illumination level of between 1000 lux and 8000 lux is taken as mild or diffused sunlight illumination conditions herein.

Nacre is a material that demonstrates the aforesaid light attenuation properties while permitting the generation of a good-quality optical image on its front surface. Nacre, also known as mother of pearl, is a biogenic organic-inorganic composite and the inner iridescent layer of molluscan shells. Nacre is composed of alternating layers of calcium carbonate and biopolymers such as chitin, conchiolin, lustrin and silk-like proteins. The calcium carbonate is in crystal form, for example, in the form of aragonite platelets such as hexagonal platelets, and occupies about 95 mass % of nacre. The biopolymers are usually in the form of an organic film and occupies about 5 mass % of nacre. The aragonite platelets are polymorph of calcium carbonate having a width of between 10-20 μm and a thickness of about 0.5 μm. The film of organic material has a thickness of about 40 nm. A nacre layer is not optically uniform because of the different shapes and sizes of the aragonite platelets and the presence of conchiolin. The nacre layers strongly diffuse incoming light to cause pearls to appear usually milky white or chalky.

An example panel body 14 includes a layer of nacre or a nacreous layer and the display surface is an integral part of the nacre or nacreous layer. In example embodiments, the display surface is a major surface of the display panel which is oriented to face away from the light source. A nacreous display surface is an iridescent display surface in which hue changes gradually with angle of observation. The nacreous display surface may be a finely polished surface which is shiny and/or reflective and which has non-uniform angles of light reflection, that is, the angle of light reflection changes on moving across or moving around the display surface. Nacre is an exceptionally tough and stiff material which can be thinned to below 1 mm to form a foil, and can be natural or synthetically made.

An iridescent display surface has an added advantage of having iridescence accompanying, surrounding or integrating with the optical image which is cast on the display surface by back illumination.

A display device having an iridescent display surface on a panel body 14 which has a high light attenuation rate produces surprisingly good visual effects when in cooperation with an electroluminescent pattern generator and the electroluminescent source which is configured to provide back illumination to form an optical image on the display surface.

The electroluminescent pattern generator may be configured to generate a textual pattern such as one comprising alphanumerical elements, a non-textual pattern such as one comprising symbols, or a combination thereof. The pattern or combination of patterns which is to be cast on the display surface may be time-variant or time-invariant. In example embodiments, the generated pattern or combination of patterns may cooperate with a background pattern which is formed on the display surface such that the generated pattern or combination of patterns and the background pattern cooperate or combine to form a complete or overall pattern. The overall pattern may be informative, decorative or a combination of both. The background pattern on the display surface may be pre-formed or post formed and may be time variant or non-time variant without loss of generality.

The display panel 10 may be a nacre layer or a composite panel comprising a nacre layer. A nacre layer may be obtained by processing of a mollusk shell, for example, by mechanical thinning of a mollusk shell. A composite panel may comprise a nacre layer such as a nacre foil which is mounted on a transparent or translucent substrate. The substrate may be a polymeric substrate such as a substrate formed of polyethylene (PE), polydiethylene glycol bisallyl carbonate resins, polycarbonate resins, polymethyl methacrylate resins or the like. The substrate may be in the form of a backing sheet. The backing sheet (or back sheet) helps to make the display panel more flexible and easier to assemble to form the display device. The nacre layer may be in the form of a nacre foil. A nacre foil strikes a good balance between good readability of an optical image formed on the display surface by back illumination, good concealability of components underneath or behind the display panel, and the luminance level of the back illumination required to produce that readability. A nacre layer suitable for forming a display panel such as a back illuminated display panel may have a thickness of between 50 μm and 2 mm, or a thickness of between 50 μm and 0.1 mm for a compact or mobile apparatus.

A plurality of example composite display panels each having an overall thickness of about 0.5 mm is used and/or evaluated as example display panels. Each example display panel comprises a nacre foil of about 0.1 mm thick and a polymer backing sheet which is attached to the nacre foil, for example, by adhesives. The example composite display panel is coupled to an electroluminescent source having a luminance level of 450 lux at the light emitting surface and the luminance level at the display surfaces of the plurality of example composite display panels is between 20 lux and 45 lux, corresponding to light attenuation rates of between 95.6% and 90%. The nacre layers of the example display panels have a thickness of between 0.08 mm to 1.2 mm.

In order that an image being casted on the display surface by the electroluminescent source 20 is visible and/or readable by a reader with naked eyes when in normal or ordinary use of the display device, the image would need to have a sufficient brightness. Trials showed that a luminance level of 20 lux would be good enough for a reader under normal ambient room illumination conditions while a luminance level of 40 lux to 45 lux would be good enough for use under mild or diffused sunlight illumination conditions. Although a brighter image would mean better readability under brighter conditions, a brighter image would mean a higher luminance output level requirement at the electroluminescent source 20. Therefore, the light source is configured to generate an image having a sufficiently high luminance level on the display surface. In example configurations, the light source is configured so that the image has a luminance level of between 20 lux and 45 lux.

An example display device comprises an example display panel and an OLED display module which is configured to provide a light emitting pattern to back illuminate the display panel. The example display module has 96×39 pixels in an active area measured 18.02×7.30 mm, with each pixel having a size of 0.188×0.188 m. Notwithstanding the adverse light transmission properties of nacre, a nacre-based display panel has demonstrated a promising and surprising optical image display capability. The light emitting pattern, which has a resolution of 53.3 pixels per cm, that is, over 100 pixel per inch, is displayed with high fidelity on the display surface after passing through the panel body.

In order that what is underneath or behind the display panel remains visually concealed during normal use when the light source is turned on or turned off, the display panel may be configured as a partition between a dark compartment which is not optically open to the ambient except via the display panel and an ambient compartment which is optically open to the ambient. In example embodiments, the dark compartment may be illuminated when what is underneath or behind the display panel is intended to be visible from above or the front.

Trials reviewed that a display panel comprising a ceramic or porcelain layer, for example, in foil forms, has comparable optical properties, except iridescence, and display concealability.

In an example embodiment, the display device is configured as a part of an example electronic display apparatus 1000. The electronic display apparatus is configured as a smart watch having the display surface 12 of the display panel 10 configured as a dial surface 1112, as shown in FIG. 2. The display surface is a polished nacre surface which has a shiny, opaque and iridescent appearance.

When the light source of the display device is turned on with the pattern generator generating an optical emitting pattern, an optical image 1002 of the optical emitting pattern is shown on the dial surface, as shown in FIG. 2A. The example image is a transient image comprising an example alphanumeric strings “compass” and “146”, a symbol “^{∘}” and a dividing line separating the two alphanumeric strings. The example dial surface is pre-formed with a background pattern which sets a backdrop for a pair of moving arms. The example moving arms comprises an hour arm and a minute arm connected to an axle which protrudes through the display panel 10. The background pattern comprises long and short minute-graduations which are commonly found on analogue watches plus an example logo. The graduations are distributed on the periphery of the display surface to surround a display window. The example display window is in an area which is free of the background pattern for better image clarity.

The hour and minute arms are parallel (including substantially parallel) to the dial surface and the axle is orthogonal (including substantially orthogonal) to the dial surface. The mantle of an analogue watch helps to conceals the substance of a smart watch, including its digital capability, artificial intelligence and wireless communication capability. The concealment of smart watch capabilities can be a valuable technical advantage, for example, in covert application, such as investigations or covert collection of evidence. Another example display panel having a nacre dial surface 2112 and a preset background pattern is shown in FIG. 3. The dial surface 2112 includes a numeral 12 at the 12 o'clock position.

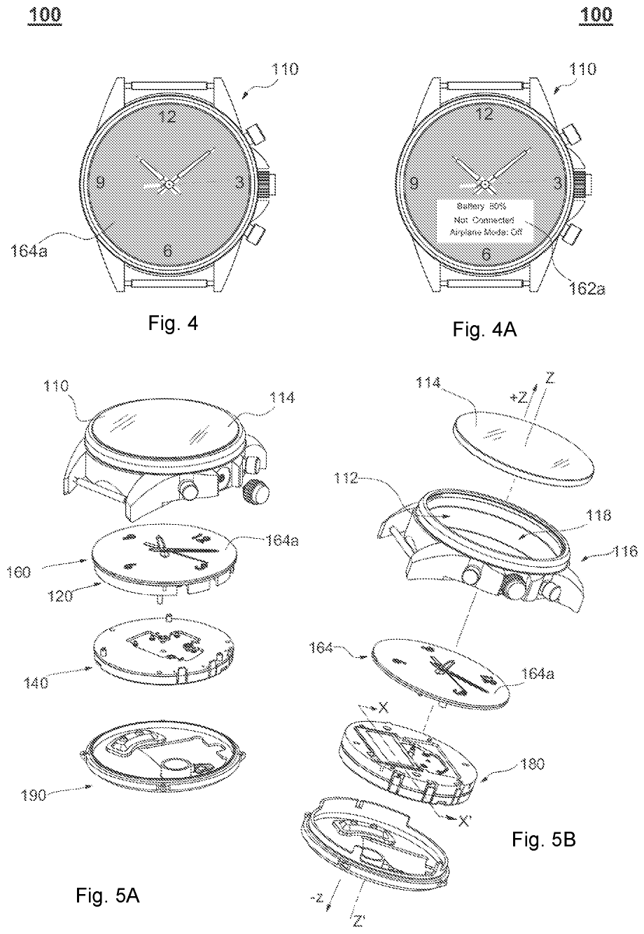

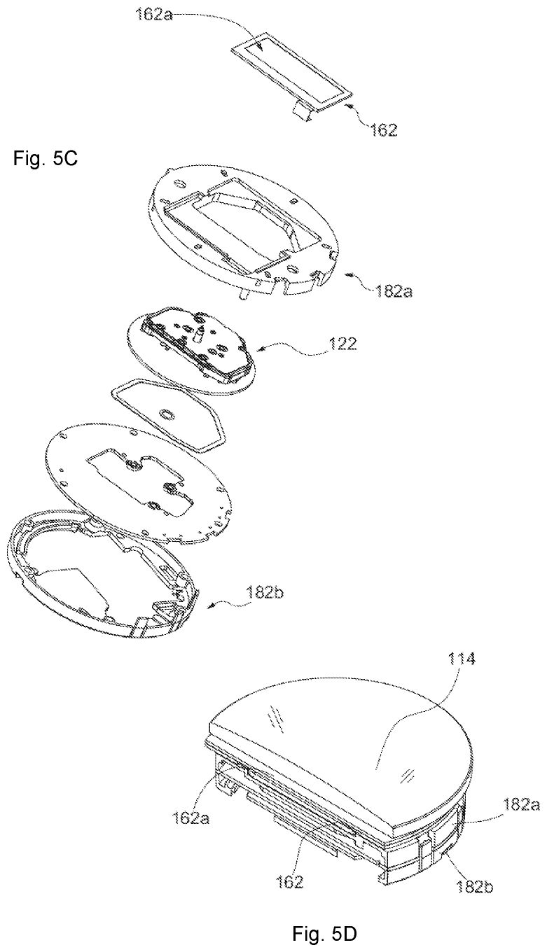

An example electronic display apparatus in an embodiment of a smart watch 100 comprises a main housing 110, a mechanical movement assembly 120, an electronic assembly 140, a display assembly 160 comprising a display panel, a component holding assembly 180 and a power source, as depicted in FIGS. 4, 4A, 5A, 5B, 5C and 5D.

The main housing 110 is a rigid body defining a main case having a main axis Z and an internal compartment 112. The main housing 110 includes a peripheral wall which extends axially between a top axial end and a bottom axial end to define the internal compartment 112. Various functional components, assemblies and sub-assemblies of the apparatus are accommodated inside the internal compartment 112. The top axial end of the main housing 110 defines a top entry aperture to the internal compartment 112 or a top aperture, and the bottom axial end of the main housing 110 defines a bottom entry aperture to the internal compartment 112 or a bottom aperture.

A viewing window 114 is mounted on the top axial end of the main housing 110 to close the entry aperture. The viewing window 114 is transparent and is made of a rigid and robust transparent material of high clarity, such as sapphire glass, mineral glass, acrylic crystal, polycarbonates, or other appropriate materials available for the time being. Optionally, the viewing window 114 is made of a scratch resistant transparent material to promote durability. The viewing window 114 is affixed or fastened to the main housing 110 by a bezel 116. The bezel 116 in this example is washer-shaped metal piece and defines a viewing aperture 118 of the apparatus. The sub-assembly comprising the bezel and the viewing window forms the outermost part of the apparatus in the axial direction, and is exposed to ambient conditions during normal uses. The viewing aperture 118 has a center axis which is usually co-axial with the Z-axis. This center axis defines a viewing aperture axis and a viewing axis.

In an embodiment, the main case is form of a single piece of metal, for example, steel, aluminum, aluminum alloy, aluminum steel alloy, or other metal or metal alloys for durability and weathering resistance. The rigid main case is known as a watch case where the apparatus is a watch, or smart watch, as a phone case where the apparatus is a smart phone, or known generally as a main housing in other apparatus.

A crown key connected to a stem and other control buttons for setting and/or operating the smart watch 100 are provided on the periphery wall of the main housing which defines the internal compartment 112. A button is also known as a push piece in the watch trade. A pair of strap holders comprising a first holder and a second holder is formed on the watch case. Optionally, the holders, which are known as lugs in trade, are integrally formed on the watch case. The first holder and the second holder are on opposite diametrical sides of the watch case and are for receiving a watch strap for securing the watch to the wrist of a wearer. The strap may be a bracelet strap, a leather strap, a plastic or rubber strap, a fabric strap or other straps available for applications.

The main housing further includes a back cover which is mounted to the bottom aperture of the main housing. The sub-assembly of the viewing window, the bezel and the back cover cooperate to define a water tight casing inside which the mechanical movement assembly 120, the electronic assembly 140, the display assembly 160, the component holding assembly 180 and the power source are retained.

The display assembly 160 comprises a display module 162, a dial member 164 and an optional back plate.

The display module 162 includes a luminous display surface 162a on which a luminous message or a plurality of luminous messages is to be formed, generated and displayed during normal operations. The message or messages to be formed or generated and displayed are time variant and are to change according to data received by the display module from time to time. The message or messages to be formed or generated and displayed are changeable, for example, changeable by user control or automatically by an embedded controller of the apparatus automatically at predetermined intervals, when triggered by events, or ad hoc. A user may change the message or messages to be formed or generated and displayed by interaction and dynamically when a user inputs instruction(s) through a user control interface, such as a control button or control buttons on the watch, for example, on the periphery of the watch case.

A message may comprise visual indicia, for example signs, symbols, icons, characters, alphabets, numerals, etc., which are formed as a pattern or a combination of patterns by selective activating a combination of display elements on the display surface of the display module from time to time. Visual indicia herein may comprise one icon or a plurality of icons, one symbol or a plurality of icons symbols, one alphabet or a plurality of alphabets, one numeral or a plurality of numerals, a character or a plurality of characters, and any combination of the aforesaid without loss of generality.

The display assembly 160 is an example display device which is held on the component holding assembly 180 with the display surface 162a oriented to face outwardly, that is, to face the viewing window 114 and the viewing aperture 118. Optionally and typically, the display surface 162a is orthogonal to the axis of the viewing aperture, that is, faces outwards and orthogonally to the axis of the viewing aperture 118.

The dial member 164 is a display panel 10 including a dial surface 164a which is a display surface of the display panel 10, which is a viewable surface that is viewable by a user from outside the apparatus in a viewing direction which is generally in the −Z direction. A plurality of signs or symbols is fixedly or permanently marked or formed on the viewable dial surface 164a. The signs of symbols are time-invariant and are marked on the viewable surface by permanent fixation means such as printing, graduation, engraving, gluing, or other forms of fixed, permanent or time-invariant marking known to persons of ordinary skill in the art. In the example of a smart watch, the signs or symbols include signs representation time of the day. In some embodiments, for example, non-watch electronic apparatus, the time-invariant markings may form a background, a backdrop or a reference template, the dial member 164 would be referred to as a background member, a backdrop member, or a template member and its viewable surface would be referred respectively to as a background surface, a backdrop surface, and a template surface.

The dial member 164 is mounted on the main case with the dial surface 164a facing upwards or outwards towards the viewing aperture 118. The dial surface 164a is a main display surface or main information display surface of the apparatus 100 and is adapted for user viewing during normal use. The dial member 164 of the example smart watch has a dial axis which is parallel to or coaxial with the axis of the viewing aperture. A central aperture is formed through the dial member 164 to permit a driving axle of the mechanical movement assembly 120 to pass or extend through. The dial surface 164a has permanent reference or template markings according to applications. For example, the markings will represent orientations when the apparatus 100 is a compass and will represent prescribed locations when the apparatus 100 is a tracking device.

The mechanical movement assembly 120 comprises a driving module 122 and time-indicating arms to be driven by the driving module to indicate time. The example driving module 122 comprises an electro-mechanical movement assembly, which includes a powered driving device such as a miniature motor including a miniature stepper motor, and a gear train driven by the stepper motor and connected to an axle such as a cannon pinion for outputting movements, such as time-indicating movements, through a cannon pinion. Optionally, the driving module 122 comprises an oscillation circuit such as a quartz oscillation circuit for generating timing pulses. The time-indicating arms are mounted on the cannon pinion at different axial levels and comprises an hour-arm, a minute-arm and optionally a second-arm. An example driving module suitable for use as an analogue watch movement is the Hattrori Y121-E5 quartz analogue movement. The example Hattori movement has a thickness of less than 3 mm, a canon-pinion having a height of not exceeding 6.8 mm, a ligne size of 6.75×8 and a hand size of 110/65/20, as an indication of example dimensions. Optionally, the driving module is held with the axis of the cannon pinion parallel to the center axis of the dial surface, that is, orthogonal to the dial surface. The driving module is typically housed within a hard-plastic housing. The operation power of the example apparatus 100 is supplied by a battery, for example, a Lithium-ion rechargeable battery. In some embodiments, the mechanical movement assembly 120 is solely mechanical power driven, for example, powered by stored mechanical energy, including spring-stored energy.

The driving module 122 and the display module 162 are held and seated together on an example component holding assembly. The example component holding assembly 180 comprises a first holding member 182a, a second holding member 182b and a plurality of fasteners which is to tighten and fasten the first and second holder members 182a, b along an axial direction parallel to the axis of the cannon pinion. The first holding member 182a is a hard-plastic slab having an external peripheral boundary substantially following or conforming to the interior boundary of the watch case for reception therein, and with its major surfaces disposed orthogonal to the axis of the viewing aperture. The first holding member 182a defines a first receptacle for receiving the display module 162 and a second receptacle for receiving the driving module 122. The first receptacle is integrally formed as an indented seat so that the display module 162 is seated squarely on the indented seat with its bottom surface in abutment contact with the seat surface and its top surface flush with the top surface of the first holding member 182a. The first holding member 182a comprises a second receptacle for receiving the driving module 122. The second receptacle is a through aperture extending axially through the first holding member 182a. The through aperture of the second receptacle is defined by an interior peripheral boundary on the first holding member 182a and has an inner peripheral boundary matched with the outer periphery of the driving module so that the driving module is retained within the lateral boundary of the second receptacle and restrained from moving laterally in a direction orthogonal to the axis of the dial surface. Threaded fasteners such as screws or unthreaded fasteners such as snap fasteners may be used for fastening the first and second holder members 182a, 182b where appropriate.

In some embodiments such as the present, both the first and second holder members 182a, 182b is in black and formed of a thermoplastic of sufficient strength and rigidity, such as ABS (acrylonitrile butadiene styrene). In some embodiments, at least one of the first and second holder members 182a, 182b is formed of a black and hard thermoplastic so that at least a major surface bearing the first receptacle which faces the viewing window of the apparatus is in black and the first receptacle is in black. In general, the component holding assembly 180 or at least the first holder member 182a is formed in a dark color for enhanced concealment of components underneath the dial member.

The example component holding assembly 180 sets a very dark background underneath the dial member and delimits a window through which the active display area of the display module 162 is exposed and viewable from outside the apparatus. As time variant information, such as messages, patterns, figures, signs, symbols, or their combination, is to be displayed on the active area of the display module 162, the window delimited by the component holding assembly 180 for exposing the active area of the display module is an information display window. The window is shaped to match the lateral shape of the display module 162 and has an interior boundary which follows the outer lateral boundary of the display module 162 for close fit. In some embodiments, a large active display area is required and the active display area of the display module may have the same or comparable dimensions as the dial surface or the viewing aperture.

In such embodiments, the entire or a substantial portion of the outward facing surface of the display module would constitute the information display window.

As the component holding assembly 180 is in black and the casing of the mechanical movement assembly 120 is also in black, the components which are underneath the dial member is well concealed when the apparatus is exposed under illuminated indoor conditions or under diffused sunlit outdoor conditions.

The electronic assembly 140 comprises a printed circuit board on which a digital assembly, a display driver, optional wired or wireless communication frontend(s), and peripheral functional circuits such as user control interface and charging circuits are mounted, preferably surface mounted. The electronic assembly 140 is connected to a battery as a power source to obtain operation power and is connected to the display module 162 to output data to the display module for display and to supply electrical power for driving the display module 162.

The digital assembly comprises a microprocessor (μP or a microcontroller) and peripheral circuits, as depicted in FIG. 8. An example digital assembly suitable for use is a device identified by product number nRF51822 of Nordic Semiconductor ASA of Norway. The nRF51822 is multiprotocol SoC suited for Bluetooth® low energy and 2.4 GHz ultra low-power wireless applications. The nRF51822 is built around a 32-bit ARM® Cortex™ M0 CPU with 256 kB/128 kB flash+32 kB/16 kB RAM for improved application performance. The embedded 2.4 GHz transceiver supports Bluetooth low energy protocol stack. The peripheral circuits may comprise wireless communication front ends to facilitate data and/or voice communications with a paired device.

An example wireless frontend comprises a wireless transceiver adapted to communicate using Bluetooth protocol, for example, BLE (Bluetooth low energy protocol). The wireless transceiver is connected to the microcontroller so that data instructions commands or messages from an external data source can be transmitted to the microcontroller for processing by the microcontroller upon execution of stored instructions, for example, instructions stored on a memory device on the digital assembly. The wireless transceiver is connected to the microcontroller so that data instructions commands or messages originating from the watch can be transmitted out of the watch to an external data processing device upon instruction of a user or the microcontroller. For example, electronic messages originated from an external data equipment, for example, a smart phone or tablet computer, can be retrieved and read by a user when displayed on the display. Alternatively, a message, for example, a voice message or command message, can be sent from the watch to an outside or an external data equipment through operation of command buttons on the watch in cooperation with the microcontroller. An antenna to facilitate external data communication is mounted on an underside of the support substrate, or more specifically on an underside of the printed circuit board.

An example display module 162 comprises display panel which is mounted on a printed circuit board and a module casing and has a connector for receiving data for display and operation power. The display panel has an active display surface 162a defining an active display area. Electro-luminescent display elements are scattered or distributed on the active display area. An electro-luminescent display element herein means one which is to become luminous when activated by an activating electrical power or current. A display module comprising an LED (Light Emitting Diode) display panel, an OLED (Organic Light Emitting Diode) display panel or a back-lit LCD (Liquid Crystal Display) display panel may be used. An OLED display device is selected for its relatively high resolution, its relatively high luminosity and compactness.

Each display element of the display module is an electro-luminescent display element, referred to as an electro-luminescent pixel (or a “pixel” in short for succinctness herein) and the plurality of pixels defined by the plurality of electro-luminescent display elements on the active display area can be selectively activated to form a pattern. Each pattern may be formed to correspond to a human readable or perceivable message and a plurality of different human readable or perceivable messages can be generated, for example, by activation of selected pixels at selected different locations or combination of different locations without loss of generality.

In order to have a display panel surface that is capable of generating a pattern having a relative high resolution so that more information or data with fines details can be accommodated within a relatively small area, an integrated circuit type display panel is preferred. However, a display panel constructed from discrete electro-luminescent display elements can also be used without loss of generality.

The electro-luminescent pixels of a display panel are usually arranged or distributed in a matrix comprising a plurality of rows of pixels and a plurality of columns of pixels. For a typical LED, OLED or LCD display panel of a relatively high resolution, the electro-luminescent pixels are arranged into a regular matrix in which the spacing between adjacent pixels in a row is a first constant or uniform, spacing between pixels in a column is a second constant or uniform, and/or the first constant and the second constant is the same such that the spacing between adjacent pixels in a row is equal to the spacing between adjacent pixels in a column. Preferably, the pixels are of the same shape and dimensions for enhanced uniformity, although the pixels may have different shapes and/or dimensions adapted for specific applications. In some specific applications, the spacing between adjacent pixels in a row may be non-uniform, the spacing between pixels in a column may be non-uniform.

An example OLED display module which is suitable for forming a visible pattern having a relatively high resolution within a relatively small active area is product no. ELW0801AC of Futaba Corporation, Japan. The ELW0801AC OLED panel is a digital display having an active area of 18.02 mm×7.30 mm (131.546 mm²), with 96 pixels distributed in a row (X-direction) having a spacing of 0.03 mm between adjacent pixels in the row and 39 pixels distributed on a column (Y-direction) having a spacing of 0.03 mm between adjacent pixels in a column. Each pixel of the OLED panel is substantially square and has a uniform pixel size of 0.158 mm in the X-direction and 0.156 mm in the Y-direction, and a uniform pixel pitch of 0.188 mm in both the X- and Y-directions. As there are a total of 3744 pixels within the active area, there are in average 28.46 pixels per square mm. This pixel density transpires into 135.3 pixels per inch (PPI) in the Y-direction and 135.7 pixels per inch (PPI) in the X-direction. A display panel having a relatively high resolution for the present applications would be one having between 101 PPI to 150 PPI, for example, having 101 PPI or more, 120 PPI or more or less, 121 PPI or more or less, 130 PPI or more or less, 131 PPI or more or less, 140 PPI or more or less, 141 PPI or more or less, 150 PPI or more or less, 151 PPI or more or less, 160 PPI or more or less, 161 PPI or more or less, 170 PPI or more or less, 171 PPI or more or less, 180 PPI or more or less, 181 PPI or more or less, 190 PPI or more or less, 191 PPI or more or less, 200 PPI or less, or any range or ranges formed by selective combination of the aforesaid values.

Each pixel of the example OLED panel is a self-luminous pixel which is to emit light when activated. The example OLED panel is to generate a white light having a luminance of between 240 cd per square meter and 360 cd per square meter when all pixels are activated, with the typical or average luminance of 300 cd per square meter.

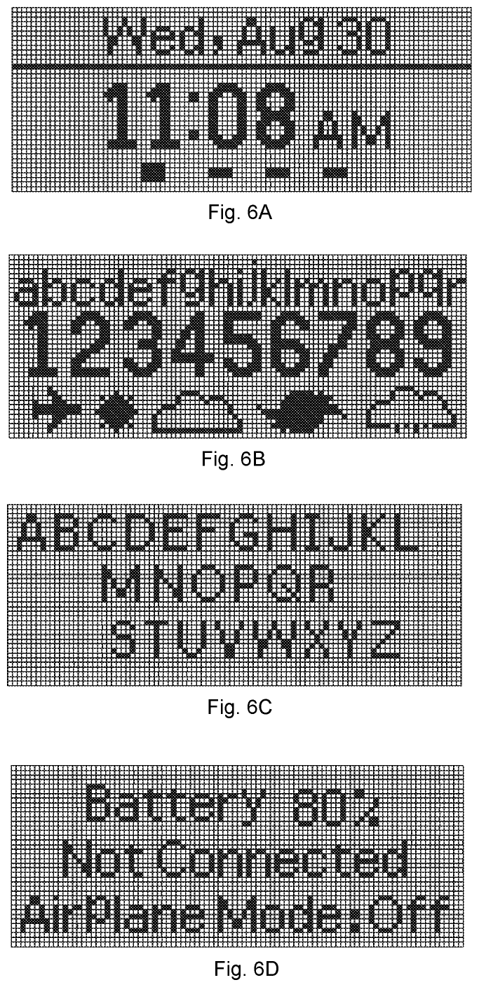

Examples patterns and messages or information constructed from different spatial combinations of pixels representing example alphabets, icons signs and symbols and example messages that can be displayed in the example active display area of the example display device are depicted in FIGS. 6A to 6D. Non-exhaustive example pixel matrix sizes required to form example elements for information display are set out below:

| | | | |
|---|---|---|---|
| 6 × 5 | a, c, e, o, n, x | 9 × 6 | w |
| 8 × 5 | d, b, g, h. p, q, y | 10 × 3 | {,} |
| | B, E, J, K, L, P, R | | |
| 7 × 4 | t | 7 × 3 | ~ |
| 8 × 4 | f, k | 8 × 6 | £, A, C, D, F, G, H, N |
| 10 × 2 | j | 3 × 3 | ° |
| 8 × 1 | i, I | 8 × 10 | ¼, ½, ¾ |
| 7 × 6 | m, ± | 14 × 12 | ° F., ° C. |
| 6 × 4 | r, s, u, v, z | 8 × 3 | I |
| 8 × 8 | M | 8 × 7 | O, Q |

The watch dial 164 comprises a dial member having a dial surface or a viewable surface which is outward facing, that is, facing the viewing aperture or the +Z-direction. A typical dial surface of a watch has a diameter of between 28 mm-36 mm. Generally, a large dial surface has a typical diameter of 36 mm, a medium dial surface has a typical diameter of between 30 mm-32 mm, and a small dial surface has a typical diameter of between 28 mm-30 mm.

The dial member 164 is formed from a nacre layer or a composite panel comprising a nacre layer. A nacre layer or a nacre composite facilitates good or easier readability of a pattern or patterns having a small size when the pattern or patterns appear on the dial surface.

A dial member is selected so that what is below or underneath the dial member, in the −Z direction, is not visible to the naked human eyes when viewed at a normal viewing distance along the viewing axis during normal use of the apparatus, whether under indoor illuminated or outdoor sunlight conditions.

A smart watch having an analogue mechanical movement with moving time-indicating arms (hour-arm, minute-arm, and/or second-arm) such as that of FIG. 4 would appear only as a conventional analogue watch with a permanently marked dial surface and with the time-indicating arms moving. When the smart watch is required to perform functions of a conventional analogue watch, that is, to indicate time according to instantaneous spatial positions of the time indicating arms with reference to the time-indicating markings on the dial member functions, the display module and other components underneath the dial member is visually concealed, when under indoor illuminated conditions or under outdoor diffused sunlit conditions. A visible information bearing message will only appear on the dial surface when a message is generated by the embedded controller. Non-visibility of the underlying display surface or other components underneath the dial member when no message is being displayed is vital to maintain integrity of dial surface design, since otherwise design of the dial surface is always subject to the constraint of having to incorporate an unsightly visible information display window revealing an unsightly display surface of the display module even when there is no information being instantaneously displayed on the information display window.

So that a message being displayed on the active display area of the display module is viewable by the naked eyes of a viewer at a normal viewing distance and angle through a translucent dial member while the active display area of the display module is to remained concealed, invisible or non-viewable to the naked eyes when viewed at the normal viewing distance and the normal viewing angle under indoor illuminated conditions or under diffused sunlit ambient conditions requires a technical scheme of solutions.

To meet such requirements, a translucent filter in the form of a dial member in the example case of a watch is disposed between the viewing window 114 and the active display area of the display module 162. The normal viewing distance in the case of a watch is usually taken as between 12 cm and 35 cm, depending on the habit and eye-sight wellness of a viewer.

During a first mode of operation when the smart watch is to appear visually as a conventional analogue watch only, the time-indicating arms above the dial surface 164a and the reference time-indicating markings on the dial surface are readable or viewable due to reflection of ambient illuminations by the time-indicating arms, the dial surface and the markings on the dial surface. To facilitate concealment of the active display area and the information display window delimiting the active display area which are underneath the translucent filter, the viewing window and the translucent filter in combination would need to attenuate the ambient illuminations impinging on the outward facing surface of the translucent filter by an adequate amount, so that what is underneath the translucent filter is not viewably exposed to the naked human eyes. The ambient illuminations herein may be due to indoor illuminations or diffused sunlight and the term “ambient illuminations” is also referred to as “ambient light” where appropriate.

During a second mode of operation when the smart watch is to generate a luminous message for user viewing, the message must have a sufficient brightness to be viewable by the naked eyes at a normal viewing distance. A sufficient brightness would be one that is over and above the brightness of the ambient illuminations.

As the luminous message would need to travel or traverse through both the viewing window and the translucent filter in order to exit from the watch and reach the naked eyes of a viewer, the combined attenuation due to the viewing window and the translucent filter must not be too high to make the luminous message too dim to be readable. In other words, the combined attenuation due to the viewing window and the translucent filter must below a threshold attenuation so that the residual luminosity of the luminous message is still sufficient to facilitate reading and viewing by the naked eyes of a viewer under illuminated conditions. To facilitate reading and viewing of the luminous message by the naked eyes of a viewer when the message appears on the marked dial surface 164a under illuminated conditions, the residual luminosity of the luminous message must have a sufficient brightness that is over and above a threshold brightness which is the brightness of the ambient illuminations.

The disposition of a translucent filter having a predetermined light attenuation level range between the active display area and the viewing window has provided a useful solution to the conflicting technical requirements of the first and second modes.

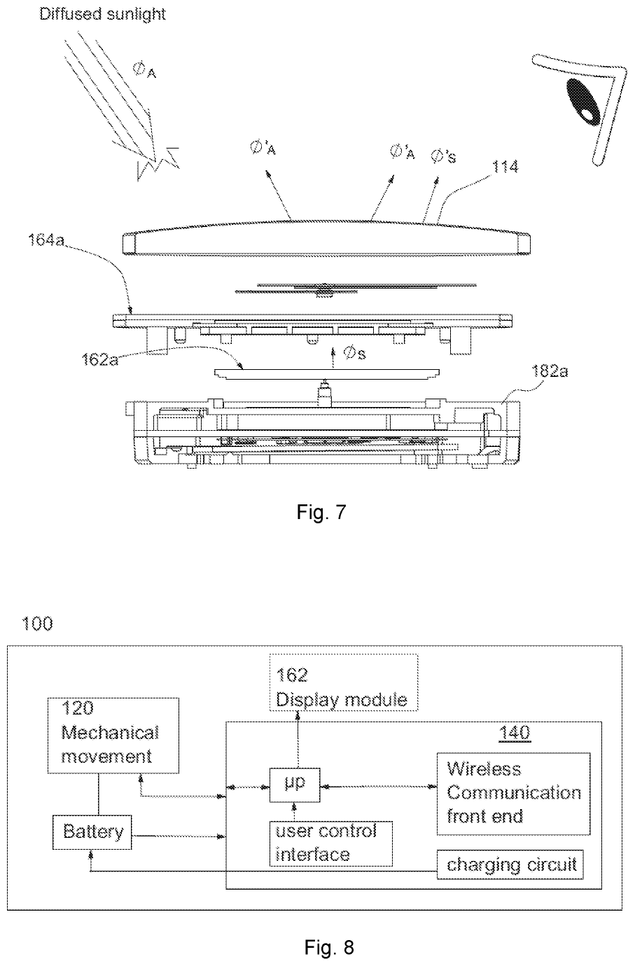

Referring to FIG. 7, incoming ambient light having a luminous level Ø_{A} at the outside surface of the viewing window 114 will have a residual luminosity having a luminous level Øᵣ on reaching the active display surface 162a of the display module, due to a first attenuation and a first partial reflection by the viewing window 114 and due to a second attenuation and a second partial reflection by the dial member 164, which comprises a translucent filter in this example. The incoming ambient light after combined attenuation and partial reflection by both the viewing window and the translucent filter member will reach the active display surface 162a and a portion of the attenuated incoming ambient light at the luminous level Øᵣ will be reflected by the active display surface 162a and moves towards the viewing window to exit. The reflected incoming ambient light will be attenuated again by the translucent filter member which is the dial member 164 in this example and the viewing window before reaching the outside surface of the viewing window.

The incoming ambient light which appears at the outside surface of the viewing window after reflection by the active display surface 162a when in the first operation mode can be expressed as: Ø′_{A}=(Ø_{A}−Δₐₜₜₙ)×R−Δₐₜₜₙ), where Ø_{A} is the luminous level of the incoming ambient light on reaching the viewing window, Δₐₜₜₙ is the combined attenuation and reflection of light due to the viewing window and the translucent window, and R is the effective reflectivity of the active display surface of the 162a of the display module, and Øᵣ=(Ø_{A}−Δₐₜₜₙ).

When in the second operation mode, which is a data display mode or a message display mode, the light emitted by the electroluminescent display or the luminous elements of the electroluminescent display having a luminosity level Ø_{S} will be attenuated by the combined attenuation due to the viewing window and the translucent window and the resulting luminosity at the at the outside surface of the viewing window when in the second operation mode can be expressed as: Ø′_{S}=(Ø_{S}−Δₐₜₜₙ).

In order that a luminous pixel or message is viewable or readable by a viewer viewing from outside of the watch at an acceptable viewing angle while under ambient illuminated conditions, the luminosity Ø′_{S} of the luminous pixel or message at the outside surface of the viewing window must be at or above a first luminous threshold level Ø′ₜₕ₁, that is, Ø′_{S}≥Ø′ₜₕ₁, where Ø′ₜₕ₁ is a minimum visibility brightness threshold level. At the same time, the luminosity Ø_{S} at the display screen of the display module, which results in a luminosity level Ø'S at the outside surface of the viewing window, should be below a threshold brightness value Ø_{b} at which the luminous pixel or message will become blurred due to over-brightness. This threshold brightness value Ø_{b} corresponds to a threshold brightness value Ø′_{b} at the outside surface of the viewing window. Therefore, it is preferred that the luminosity level Ø_{S} at the display screen of the display module is at or below Ø_{b} for good displayed message clarity, where Ø_{b} is a blurring luminance threshold and Øₜₕ₁ is a minimum visibility brightness threshold level at the display screen of the display module corresponding to the minimum visibility brightness threshold level at the outside surface of the viewing window. Where the blurring threshold Ø_{b} is equal to or larger than the visibility threshold Øₜₕ₁, the value of Ø_{S} can be a value between Øₜₕ₁ and Ø_{b}, that is Øₜₕ₁≤Ø_{S}≤Ø_{b}. However, where the value of Ø_{b} at the display screen of the display module is lower than the readability threshold value of Øₜₕ₁, that is, the value of Ø′_{b} at the outside surface of the viewing window is lower than the value of Ø′ₜₕ₁, the luminosity level Ø_{S} at the display screen of the display module may be selected at a level which is between Ø_{b} and Øₜₕ₁ as a convenient balance or compromise, where Ø′_{b} is a blurring luminance threshold at the outside surface of the viewing window. Therefore, a preferred display module to be selected for the present application should meet the criteria Øₜₕ₁≤Ø_{S}≤Ø_{b} at the display screen of the display module, or the criteria O′ₜₕ₁≤Ø′_{S}≤Ø′_{b} at the outside surface of the viewing window, while a workable display module would meet Ø_{b}≤Ø_{S}≤Øₜₕ₁ or the corresponding relationship Ø′_{b}≤Ø′_{S}≤Ø′ₜₕ₁ at the outside surface of the viewing window.

In order that the active display surface 162a is concealed under ambient illuminated conditions when operating in the first operation mode, that is, an analog watch-only operation mode in this example, the luminosity Ø′_{A} of the residual ambient light after reflection by the active display surface 162a and on appearing on exit at the outside surface of the viewing member should be below a second luminous threshold level, i.e. Ø′_{A}<Øₜₕ₂. This second luminous threshold level Øₜₕ₂ is a threshold of visibility Thᵥ. above which the display screen of the display module becomes visible under ambient illuminated conditions due to Ø_{A}. When under outdoor sunlight ambient conditions, Ø_{A}=Ø_{A_sunlight} and the threshold of visibility Thᵥ under sunlight ambient conditions is Th_{v_sunlight}.

To meet the second luminous threshold level, Ø′_{A}<Øₜₕ₂, that is, Ø′_{A}<Thᵥ. When under sunlit illuminated ambient conditions, the relationship becomes: Ø′_{A}<Th_{v_sunlight}.

To facilitate effective concealment of what is underneath the dial member, the translucent dial member would preferably have an attenuation Δₐₜₜₙ meeting the requirements below:

Ø′_{S}=(Ø_{S}−Δₐₜₜₙ)≥Ø′ₜₕ₁, and

Ø′_{A}=(Ø_{A}−Δₐₜₜₙ)×R−Δₐₜₜₙ)<Thᵥ or <Th_{v_sunlight} when Ø_{A}=Ø_{A_sunlight}.

In general, the translucent dial member would have an attenuation Δₐₜₜₙ between a first attenuation threshold Δₜₕ₁ and a second attenuation threshold Δₜₕ₂.

The luminosity ϕ′ₛ of the luminous pixel or message at the outside surface of the viewing member is related to the luminance output or luminosity output of the display module ϕₛ, where ϕₛ=F cd/m². In this example, the source luminosity of the OLED display under a full lit condition is at 300 cd/m² (cd per square meter), which is equivalent to 280 Lux at the active display surface in this example.

Luminance is a term which specifies the visual brightness of an object and is a major determinant of perceived picture quality in an LCD. Luminance is commonly referred to as brightness and is specified in candelas per square meter (Cd/m²) or nits.

In order that a luminous pixel or message displayed on the display module is readable under outdoor sunlight conditions, the message must be bright enough. In general, a typical outdoor LCD display requires a luminous level of 1000 nits or more. However, such a high luminance level means a relatively high power consumption and a relatively high heat dissipation, and is not practical or desirable for wearable electronic devices such as a smart wrist watch of the present example.

Furthermore, the display screen of the display module has a relatively high resolution (26-35 pixels per square mm and a pixel pitch of less than 0.2 mm between adjacent pixels. A high luminous level ϕₛ at the display screen of the display will result in a substantially blurred displayed message. A source luminosity of, say, between 260 and 350 Cd/m²) has been found to provide a balance between message clarity and readability.

The backing sheet may be doped with pigments in order to be translucent. In order to have a high clarity and a low haze, the pigments would need to have the same or matched refractive index as that of the base plastic material.

The microcontroller is set to operate in several alternative modes, for example, an analogue watch only mode, a digital mode including a message mode and/or a compass mode, and a hybrid mode comprising the watch-node and the message mode. During the analogue only mode, the smart watch operates in a watch mode and appears like a conventional analogue wrist watch. During the message mode, data will be displayed on a data display window on the smart wrist watch. The data display window is concealed under the watch dial during the analogue watch only mode to maintain appearance integrity of the watch dial surface, under indoor illuminated conditions and outdoor sunlit ambient conditions.

When in the analogue watch only mode, the analogue watch movement is operational to provide time information in a conventional manner through the time arms, that is, hour arm, minute arm, and/or second arm. In some embodiments, the watch movement includes timing arm or uses the time arms to perform timing function without loss of generality. In some embodiments, a watch movement including calendar function is included and a display window for display of calendar information is formed on the display member, which is also referred to as a watch dial. During this mode and under normal ambient lighting conditions, only the dial surface, the time arms and the marker prints are apparent to a user. What is underneath the display member is not visible or apparent to a user due to the partially reflective surface. When in the analogue watch only mode, the microcontroller is in hibernation and the display is not in a luminescent condition.

In use as a wrist watch, a user wears the smart watch on a wrist and the smart watch is to operate like a normal analogue watch.

To operate in the digital mode or the hybrid mode, a user will set up a communication link between the smart watch and an external data device such as a smart phone, a tablet or laptop computer. For example, the user may perform Bluetooth or WiFi pairing steps to pair up the smart watch and the external data device to provide a secured data communication link.

When in the hybrid mode, the wearable device is to operate in both the analogue watch mode and in the digital mode. When in the digital mode, the microcontroller is to set the display into a display mode operation and the display panel will become luminescent with power supplied from the power assembly as controlled by the microprocessor. In this mode, the microcontroller will generate information messages on the display for user reading. The information messages may include, for example, a message alert that there is a new message received, a reminder or other short messages without loss of generality. In some embodiments, a user may operate the smart watch to make a short telephone call or to send a short message out through the smart phone. When in the hybrid mode, the analogue watch movement is not affected and remain in operation. In some embodiments, operation of the analogue movement may be halted during the digital mode operations so that the smart watch is in a pure digital mode operation.

When in the digital mode operation, the electroluminescence of the display panel will generate a visible message by way of localized and confined electroluminescence and the visible message will appear to a user as forming on the dial surface. Due to the localized and confined electroluminescence, what is visible to a user is the data message due to the localized and confined electroluminescence plus what appears on the dial surface during hibernation or non-operation of the electroluminescent display panel, thereby creating a classic analogue watch having the additional data communication function of a smart watch. As voice communication is nowadays modulated in digital form to facilitate transmission, the data communication function also facilitates voice communication without loss of generality.

During data operations when high frequency radio frequency signals, for example, radio frequency signals of 2-5 GHz suitable for Bluetooth or WiFi operations, the partially reflective viewing surface provides a lower RF (radio frequency) resistance gateway to facilitate travelling of RF signals across the device. In some embodiments such as the present, the partially reflective viewing surface is metallic and has an attenuation effect to incident RF signals and will attenuate incident operational radio frequency signals by 3 dB to 5 dB when the incident operational radio frequency signals traverse through the partially reflective viewing surface.

When the wearable device is transmitting, the wireless data transmitter is to transmit operational radio frequency signals so that the RF power immediately outside the device, for example, at immediate proximity to the watch viewing window, is at a power level of between −10 dBm to −30 dBm.

In example embodiments, the smart watch may be configured to optionally operate as a compass. When operating as an electronic compass, the microcontroller (or μP) will operate to receive GPS signals and to translate received GPS signals as orientation information for display. To display orientation information, the microcontroller will operate the mechanical movement assembly so that the arms are moved to positions indicating orientations, for example, in degrees with reference to the North or South direction etc.

While the disclosure has been described with reference to examples and embodiments, the examples and examples and embodiments are not intended to restrict the scope of disclosure and should not be used to limit or restrict the scope of disclosure.

For example, while the Bluetooth or BLE communication protocols have been referred to, other communication norms such as IEE802.11 family or other wireless communication norms are useable without loss of generality.

Furthermore, while a smart watch has been used as a convenient example of a wearable electronic device, other example wearable electronic device may include fitness monitors, health monitors, heart rate monitors having a display panel and an analogue display surface similar or equivalent to a watch dial surface without loss of generality.

In example embodiments, stepper motors are used to operate the time-indicating arms. For example, 3 stepper motors are used to operate the second-arm, the minute-arm and the hour-arm respectively. Each of the 3 arms may operate independently and move in different direction in different speed. Each of the minute-arm and hour-arm move with 360 steps per cycle, while the second-arm moves with 60 steps per cycle. In a watch mode and in the first mode of operation when the smart watch is to appear visually as a conventional analogue watch only, the second-arm moves one step every second, the minute-arm moves one step every 10 seconds, and the hour-arm moves one step every 120 seconds.

In the second mode of operation when the smart watch is to generate a luminous message for user viewing, the electronic assembly 140 will check if the arms are above and crosses the luminous display surface 162a and move the arms away from the luminous display surface 162a such that the arms would not obstruct viewing of the luminous message. In an example, as depicted on FIG. 4A, the luminous display surface 162a is at the lower part of the viewing window 114. Taking 12 o'clock position as the 0° and the center axis of the dial surface as the origin, the luminous display surface 162a is at a viewing angle range between around 132° to around 228° on the viewing window 114, which correspond to approximately 22 minute position to 38 minute position. If the arms are within the viewing angle range, they will be instructed to move to target positions which are outside the viewing angle range. For example, the second and minute arms may be instructed to move to 90°, corresponding to 15 minute position, and the hour-arm may be instructed to move to 270°, corresponding to 45 minute position. The luminous display surface 162a may be located at the upper part of the viewing window 114, or left or right side of the viewing window 114 without loss of generality. The viewing angle may comprise any range taken between 0° to 360°, for example 0° to 48°, 42° to 138°, 222° to 318°, 222° to 318°, 312° to 360° or combinations of two or more ranges between 0° to 360°. The arms may be instructed to move to any other target positions.

The electronic assembly 140 operates to determine the direction of movement of the arms in reaching the target positions. The current positions of the arms are stored in the memory in the microprocessor. For each of the arms may move in clockwise or anti-clockwise in different speed. The microprocessor calculates the distance from the current position to the target position in both clockwise and anti-clockwise directions, compares whether the arm could reach the target position in a shorter time by moving clockwise or anti-clockwise, and instructs the stepper motors to turn accordingly.

In an example embodiment, the arm moves at 64 Hz in clockwise direction and at 32 Hz in anti-clockwise direction, the electronic assembly 140 determine the direction of movement as follows:—

1. Calculating the number of steps required for moving the arm from the current position to the target position in clockwise direction (P)

2. Calculating the number of steps required for moving the arm from the current position to the target position in anti-clockwise direction (Q)

if (P/2)>Q, instructing the arm to move Q steps in anti-clockwise direction; otherwise instructing the arm to move P steps in clockwise direction.

The example smart watch is optionally also operable as an electronic compass. The example smart watch obtains current compass reading by a built-in magnetometer or embedded GPS units. To convert into compass operation while in a watch mode, at least one of the arms of the example smart watch move to a target arm position, pointing to a compass direction as if an ordinary compass dial. The rest of the arms or parking arms move to a target arm position and stay at the target arm position until the end of the compass operation.

In an example compass mode, the second-arm parks at its target arm position, the minute and hour arms move to their corresponding target arm positions according to the current compass reading C. For example, the second-arm parks at 90°, corresponding to 15 minute position. The minute-arm moves to a minute target position M, where M=(360−C) position, and the hour-arm moves to an hour target position H, where H=(540−C) position. If M or H is bigger than or equal to 360, it may be adjusted by minus 360.

The electronic assembly 140 is operable to calculate the direction of movement of the arms, such that the arms move as fast as possible to the target positions. For example, when both arms move at 32 Hz for both clockwise and anti-clockwise directions, the electronic assembly 140 determine the direction of movement as follows:—

1. Calculating the number of steps required for moving the arm to the target position in clockwise direction (P)

2. Calculating the number of steps required for moving the arm to the target position in anti-clockwise direction (Q)

3. if P>Q, instructing the arm to move Q steps in anti-clockwise direction; otherwise instructing the arm to move P steps in clockwise direction.

Furthermore, while a smart watch has been used as a compass, other example smart watch may be programmed for other purpose without loss of generality. For example, the smart watch may utilize the GPS information and operable as a direction pointer. In this case, instead of pointing to a compass direction, the arms are programmed to point to the direction to a location.

While the panel body of the present description has a layer of nacre or a nacreous layer, it would be appreciated that other materials comprising crystalized calcium carbonate, porcelain, ceramics, China, quartz or mica can also be applied mutatis mutandis without loss of generality. The thickness of porcelain, ceramics, China, quartz or mica may be, for example, 0.05 to 0.1 and/or 0.2 mm.

While the disclosure has been described herein with reference to examples, the examples are not intended and should not be used to limit the scope of disclosure.

1. A display device comprising a display panel and an electroluminescent light source, wherein the display panel includes an intermediate layer and a display surface, wherein the electroluminescent light source is configured to project light through the intermediate layer to form an information display on the display surface, and wherein the intermediate layer comprises one or more layers selected from crystalized calcium carbonate, porcelain, ceramics, China.

2. The display device of claim 1, wherein the intermediate layer comprises hexagonal platelets of crystalized calcium carbonate of 10 μm-20 μm wide.

3. The display device of claim 1, wherein the intermediate layer comprises platelets of crystalized calcium carbonate of 0.4 μm-0.6 μm thick.

4. The display device of claim 1, wherein the intermediate layer comprises platelets of aragonite.

5. The display device of claim 1, wherein the intermediate layer comprises a calcareous layer.

6. The display device of claim 1, wherein the intermediate layer comprises platelets of aragonite arranged in a plurality of parallel lamina.

7. The display device of claim 1, wherein the intermediate layer is a polished mollusk shell.

8. The display device of claim 1, wherein the intermediate layer comprises a polished nacreous layer of a mollusk shell.

9. The display device of claim 1, wherein the display surface is a polished surface comprising platelets of crystalized calcium carbonate.

10. The display device of claim 1, wherein the display surface is a polished surface comprising platelets of aragonite.

11. The display device of claim 1, wherein the display surface is a nacreous surface.

12. The display device of claim 1, wherein the display surface is an iridescent surface.

13. The display device of claim 1, wherein the display panel has a thickness of between 0.4 mm and 0.5 mm.

14. The display device of claim 1, wherein the electroluminescent source is configured to generate a visible image on the display surface by providing back illumination to the display panel.

15. The display device of claim 1, wherein the display device comprises a pattern generator which is configured to generate a light emitting pattern having a resolution of higher than 50, 60, 70, 80, 90, 100 pixels, per centimeter.

16. An electronic apparatus comprising a display device, wherein the display device comprises a display panel and an electroluminescent light source, wherein the display panel includes an intermediate layer and a display surface, wherein the electroluminescent light source is configured to project light through the intermediate layer to form an information display on the display surface, and wherein the intermediate layer comprises one or more layers selected from crystalize calcium carbonate, porcelain, ceramics, China.

17. The electronic apparatus of claim 16, wherein the display surface is a shiny and/or reflective polished nacreous surface.

18. The electronic apparatus of claim 17, wherein the display panel comprises a panel body which includes a nacre layer or a nacreous layer and the display surface is an integral part of the nacre layer or the nacreous layer.

19. The electronic apparatus of claim 17, wherein the display panel comprises a first surface which is the display surface, a second surface which is a back surface, and the intermediate layer that is intermediate the first surface and the second surface; and wherein the electroluminescent light source is configured to project light to generate a luminance level of between 20 lux and 45 lux on the display surface.

20. The electronic apparatus of claim 16, wherein the display device comprises a pattern generator which is configured to generate a light emitting pattern on the display surface, the light pattern having a resolution of higher than 50, 60, 70, 80, 90, 100 pixels per centimeter.
